(19) United States
(12) Patent Application Publication
(10) Pub. No.: US 2026/0104247 A1
(43) Pub. Date: Apr. 16, 2026

(54) MEASURING DEVICE AND ERROR CALIBRATION METHOD FOR MACHINE TOOL USING THE SAME

(71) Applicant: INDUSTRIAL TECHNOLOGY RESEARCH INSTITUTE, Hsinchu (TW)

(72) Inventors: Chia-Ching LIN, Taichung City (TW); Hsin-Chang CHANG, Taichung City (TW); Ming-Chi CHEN, Taichung City (TW); Chih-Ping CHENG, Miaoli County (TW)

(73) Assignee: INDUSTRIAL TECHNOLOGY RESEARCH INSTITUTE, Hsinchu (TW)

(21) Appl. No.: 18/957,076

(22) Filed: Nov. 22, 2024

(30) Foreign Application Priority Data
Oct. 15, 2024 (TW) 113139101

(51) Int. Cl. G01B 11/00; B23Q 17/22

(52) U.S. Cl. CPC G01B 11/005; B23Q 17/2233

(57) ABSTRACT

A measuring device and an error calibration method for a machine tool. The measuring device includes a housing, a movable component, a calibration ball and a sensing switch. The housing has an inner space. The movable component is movably disposed in the inner space. The calibration ball is disposed on an end of the movable component and at least partially located outside the housing. The sensing switch is disposed in the inner space and configured to detect a movement of the movable component relative to the housing.

### CROSS-REFERENCE TO RELATED APPLICATIONS

All related applications are incorporated by reference. The present application is based on, and claims priority from, Taiwan (International) Application Serial Number 113139101 filed on October 15, 2024, the disclosure of which is hereby incorporated by reference herein in its entirety.

### Technical Field

The disclosure relates to a measuring device and an error calibration method for a machine tool using the measuring device.

### Background

In related art, in order to calibrate the error of rotary units of a five-axis machine tool, a contact detector of R-test system or a non-contact detector of Laser R-test (LRT) system, such as the detector 10 in the patent numbered U.S. Pat. No. 7,852,478, is used to measure a reference point length by cooperating with a calibration ball. Then, an error analysis of each rotary unit is performed based on the reference point length to calculate a rotational center position of the rotary unit, thereby compensating the error of the rotary unit.

### SUMMARY

One embodiment of this disclosure provides a measuring device including a housing, a movable component, a calibration ball and a sensing switch. The housing has an inner space. The movable component is movably disposed in the inner space. The calibration ball is disposed on an end of the movable component and at least partially located outside the housing. The sensing switch is disposed in the inner space and configured to detect a movement of the movable component relative to the housing.

Another embodiment of this disclosure provides an error calibration method for a machine tool, using the measuring device, a LRT detector, a computing unit and a controller to perform an error calibration on the machine tool, the error calibration method being a series of programs performing following steps after being read by the computing unit: forcing an end of a spindle of the machine tool to push the calibration ball disposed on the movable component by the controller, thereby obtaining a first Z-axis coordinate value of the spindle and obtaining a first height value of the measuring device based on the sensing switch in the measuring device that is configured to detect the movement of the movable component; controlling a tool turret of the machine tool to install the LRT detector to the spindle by the controller, and moving the spindle to allow the LRT detector to obtain an offset error of 0 of the calibration ball by moving the calibration ball to a central position of the LRT detector, thereby obtaining a second Z-axis coordinate value of the spindle and a second height value of the measuring device; and calculating a reference point length based on the first Z-axis coordinate value, the first height value, the second Z-axis coordinate value and the second height value by the computing unit.

Still another embodiment of this disclosure provides an error calibration method for a machine tool, using the measuring device, a LRT detector, a computing unit and a controller to perform an error calibration on the machine tool, the error calibration method being a series of programs performing following steps after being read by the computing unit: using the measuring device and the computing unit to obtain an error value of the machine tool by performing an error analysis based on a reference point length; and calibrating a first rotary unit and a second rotary unit of the machine tool by the computing unit based on the error value of the machine tool.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a schematic plan view of an error calibration system according to a first embodiment of the disclosure;

FIG. 2 is a plan view of a measuring device of the error calibration system in FIG. 1;

FIGS. 3 to 7 are flow charts showing an error calibration method using the error calibration system in FIG. 1 and a LRT detector;

FIGS. 8 to 10 are schematic plan views showing the error calibration method in FIGS. 3 to 7; and

FIGS. 11 and 12 are plan views of a measuring device according to a second embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

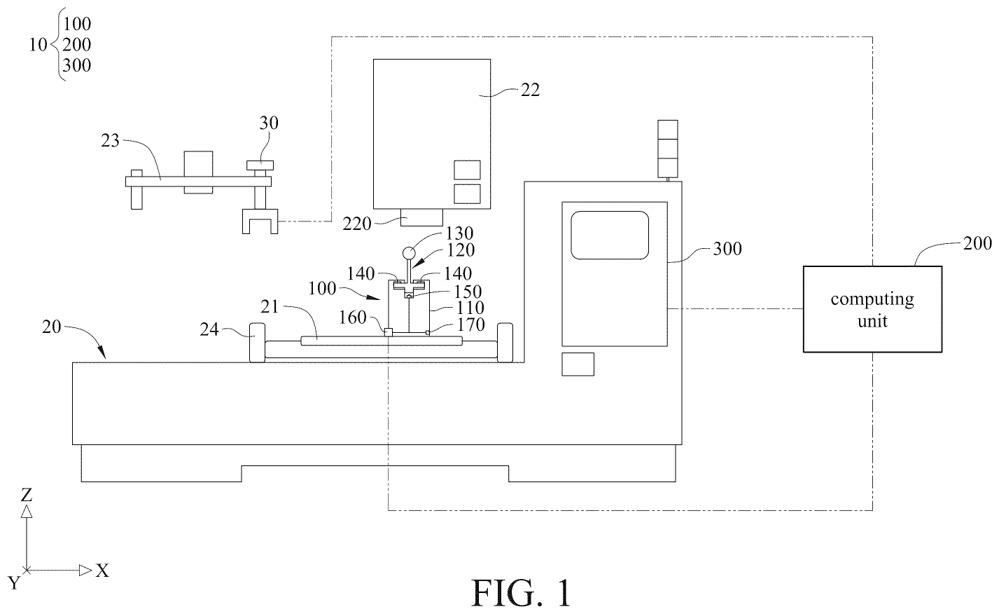

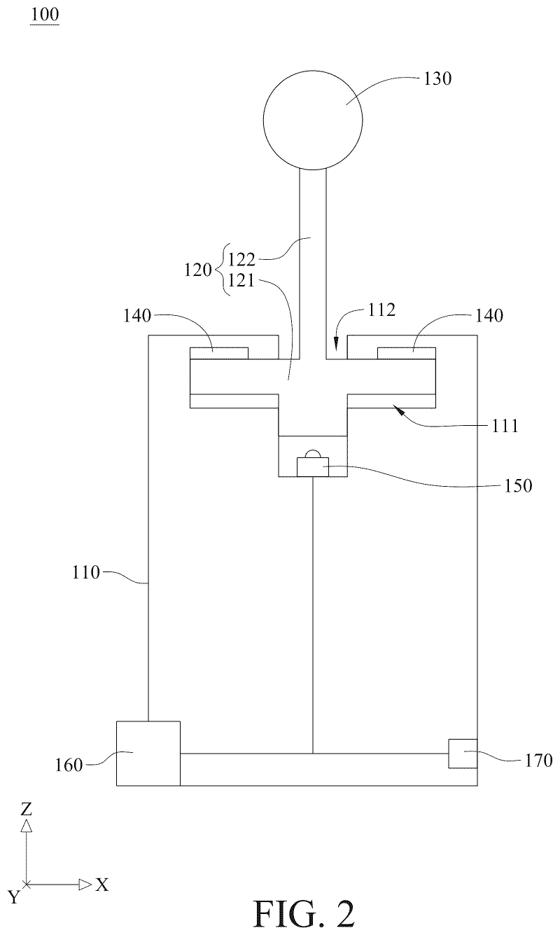

Please refer to FIGS. 1 and 2. FIG. 1 is a schematic plan view of an error calibration system 10 according to a first embodiment of the disclosure. FIG. 2 is a plan view of a measuring device 100 of the error calibration system 10 in FIG. 1.

In this embodiment, the error calibration system 10 is configured to calibrate an error of a machine tool 20, and mainly includes the measuring device 100 and a computing unit 200; the machine tool 20 is, for example, a five-axis machine tool, and is usually connected to a controller 300 for controlling the movement of each rotary unit included therein.

In this embodiment, the measuring device 100 includes a housing 110, a movable component 120, a calibration ball 130, a magnet 140, a sensing switch 150, a signal output port 160 and a light emitting component 170. The housing 110 includes, for example, an inner space 111 and an opening 112 connected to the inner space 111.

In this embodiment, the movable component 120 is, for example, slidably disposed in the housing 110. In detail, in this embodiment, the movable component 120 includes, for example, a slider portion 121 and a mounting protrusion 122. The mounting protrusion 122 protrudes from a side of the slider portion 121. The slider portion 121 is slidably disposed in, for example, the inner space 111 of the housing 110. The mounting protrusion 122 stick out of the housing 110 by penetrating through, for example, the opening 112 of the housing 110.

For example, the calibration ball 130 is disposed on an end of the mounting protrusion 122 located away from the slider portion 121 and at least partially located outside the housing 110. The calibration ball 130 may be, for example, a spherical standard ball or a spherical lens, where the spherical standard ball may be made by, for example, metal, plastic, glass and the like, and the spherical lens may be made by, for example, a transparent material such as glass and plastic. In addition, the calibration ball 130 may be disposed on the mounting protrusion 122 by, for example, adhering, but the disclosure is not limited thereto. In other embodiments, the calibration ball may be fixed or movably disposed on the mounting protrusion by an additional connecting rod or the like.

The magnet 140 is disposed in the housing 110 and configured to attract the movable component 120. For example, there may be one or more magnets 140. In this embodiment, there may be two magnets 140 arranged in the housing 110 in an average or uniform manner, the two magnets 140 are relatively and respectively located on two side parts of the slider portion 121, and one or more magnetic components (not shown) may be attached to the two side parts of the slider portion 121. Thus, the movable component 120 may be attracted to the housing 110 by magnetic force in an average or uniform manner. In this way, the two magnets 140 can attract the movable component 120 in an average or uniform manner. Note that the disclosure is not limited by the number of the magnets 140. In other embodiments, the measuring device may include one magnet that is in a ring shape, or may include three or more magnets that are arranged in an average or uniform manner, as long as the magnets can attract the movable component in an average or uniform manner.

Further, in this embodiment, by attracting the movable component 120 via the magnet 140, it is ensured that the movable component 120 is prevented from being inclined during the movement or the vibration of the measuring device 100, thereby ensuring the accuracy of the following measurement and calibration.

For example, the sensing switch 150 is disposed in the inner space 111 of the housing 110 and configured to detect the movement of the movable component 120 relative to the housing 110. In this embodiment, the sensing switch 150 is, for example, a tact switch, and is triggered by being in contact with the movable component 120. Note that the disclosure is not limited by the type of the sensing switch. In other embodiments, the sensing switch may be an optical ruler, a laser rangefinder or any type of position sensor that can detect the movement of the movable component relative to the housing.

For example, the signal output port 160 is disposed on the housing 110 and electrically connected to the sensing switch 150 and the computing unit 200. Note that in this disclosure, the electrical connected between the electronic components may be realized by one or more cables or wireless communication.

For example, the light emitting component 170 is disposed on the housing 110 and exposed to the outside from the housing 110. The light emitting component 170 is electrically connected to the signal output port 160. The light emitting component 170, for example, is configured to emit light when the sensing switch 150 is triggered. The light emitting component 170 is, for example, a light emitting diode or any type of component that can emit light. In other embodiments, the measuring device may not include the light emitting component.

The computing unit 200 is electrically connected to the sensing switch 150 via the signal output port 160. The computing unit 200 is, for example, a processor or a computer external to the machine tool 20. The controller 300 is electrically connected to the computing unit 200 and is configured to control the machine tool 20. The controller 300 may be, for example, a processor internal or external to the machine tool 20.

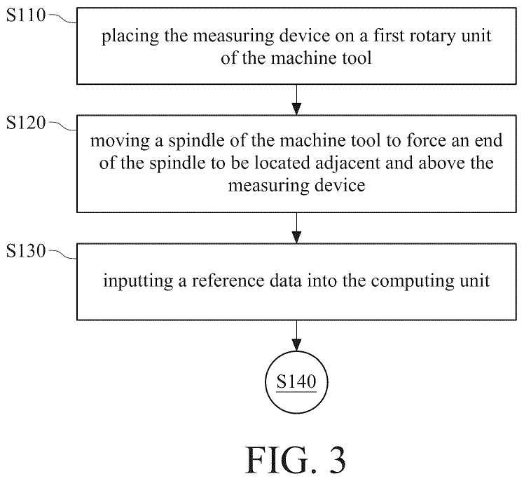

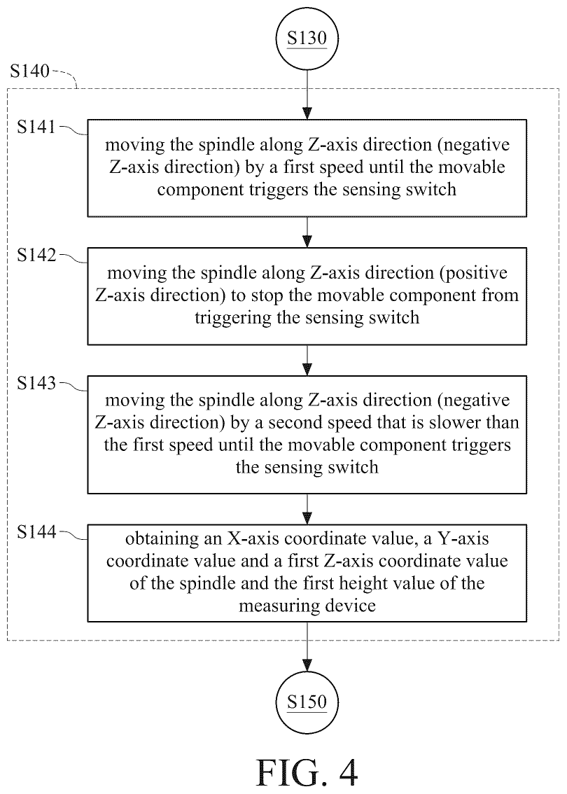

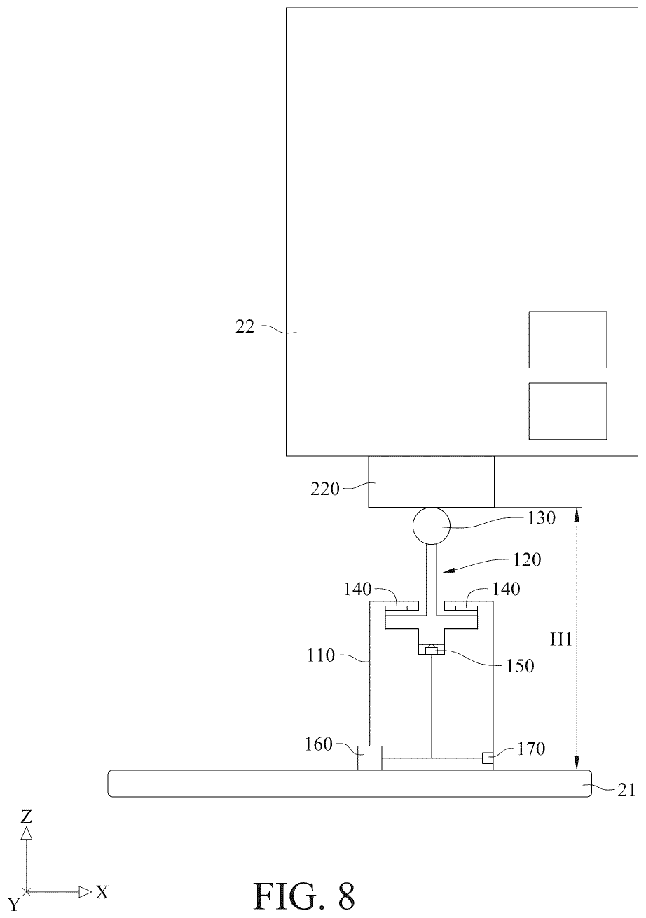

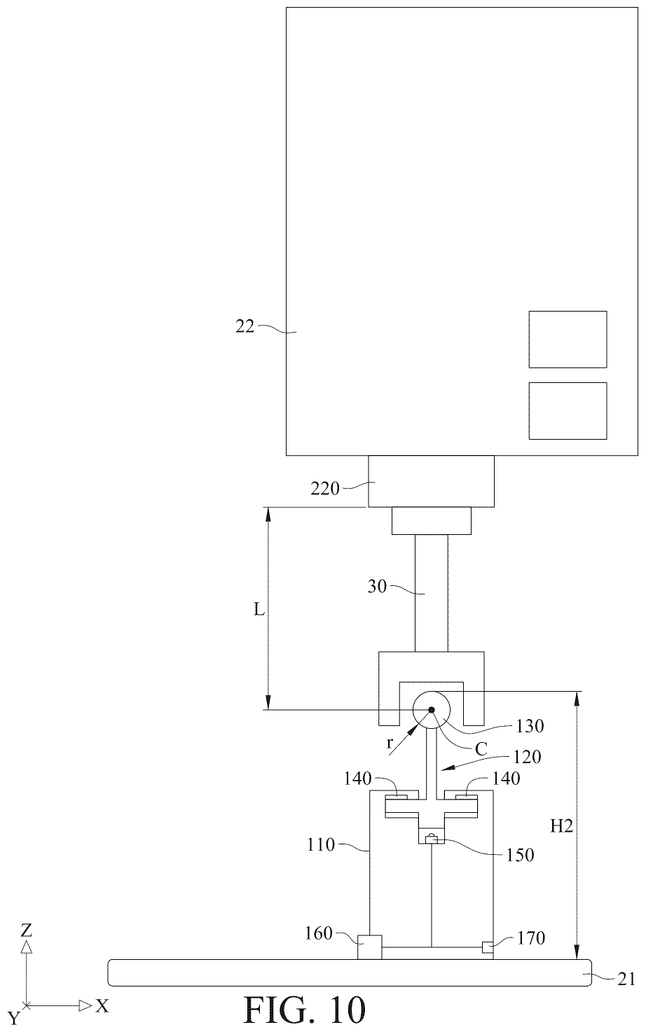

Hereinafter, an error calibration method using the error calibration system 10 in FIG. 1 and a LRT detector 30 will be described by referring to FIG. 1 and FIGS. 3 to 10. FIGS. 3 to 7 are flow charts showing the error calibration method using the error calibration system 10 in FIG. 1 and the LRT detector 30. FIGS. 8 to 10 are schematic plan views showing the error calibration method in FIGS. 3 to 7. In this embodiment, the error calibration method using the error calibration system 10 and the LRT detector 30 may include following steps which are performed after programs stored in the computing unit 200 are read by the computing unit 200.

As shown in FIGS. 1 and 3, a step S110 is firstly performed to place the measuring device 100 on a first rotary unit 21 of the machine tool 20. Then, for example, a step S120 is performed to move a spindle 22 of the machine tool 20 by the controller 300 to force an end 220 of the spindle 22 to be located adjacent and above the measuring device 100. Then, for example, a step S130 is performed to input a reference data into the computing unit 200. The reference data may include reference coordinate data and reference height data. The reference coordinate data include, for example, an X-axis reference coordinate value and a Y-axis reference coordinate value of the spindle 22 measured when the spindle is adjacent to the measuring device 100. Also, the reference height value includes, for example, a first height reference value of the movable component 120 relative to the first rotary unit 21 measured when the movable component 120 is attracted by the magnet 140 and a second height reference value of the movable component 120 relative to the first rotary unit 21 measured when the sensing switch 150 is triggered by the movable component 120.

As shown in FIGS. 1, 4 and 8, then, for example, a step S140 is performed to force the end 220 of the spindle 22 to push the calibration ball 130 disposed on the movable component 120 by the controller 300, thereby obtaining a first Z-axis coordinate value of the spindle 22 of the controller 300 by the computing unit 200, and obtaining a first height value H1 of the measuring device 100 relative to the first rotary unit 21 based on the sensing switch 150 in the measuring device 100 that is configured to detect the movement of the movable component 120. In detail, in this embodiment, the step 140 includes, for example, four steps S141-S144. In step S141, for example, the controller 300 forces the spindle 22 to be moved along Z-axis direction (negative Z-axis direction) by a first speed until the movable component 120 triggers the sensing switch 150. In the step S142, for example, the controller 300 forces the spindle 22 to be moved along Z-axis direction (positive Z-axis direction) to stop the movable component 120 from triggering the sensing switch 150. In the step S143, the controller 300 forces the spindle 22 to be moved along Z-axis direction (negative Z-axis direction) by a second speed that is slower than the first speed until the movable component 120 triggers the sensing switch 150. In the step S144, for example, an X-axis coordinate value, a Y-axis coordinate value and a first Z-axis coordinate value of the spindle 22 and the first height value H1 of the measuring device 100 are obtained by the computing unit 200. For example, when the movable component 120 triggers the sensing switch 150 or is stopped from triggering the sensing switch 150, the signal output port 160 sends signal to the computing unit 200 so as to allow the computing unit 200 to calculate the above values.

In this embodiment, the spindle 22 triggers the sensing switch 150 by being moved by a faster speed (i.e., the first speed) before being moved by a slower speed (i.e., the second speed). Thus, the position at which the spindle 22 triggers the sensing switch 150 is ensured to be consistent. In other embodiments, if the sensing switch is an optical ruler, an encoder or the like that can directly obtain the position information of the spindle, the spindle may not be moved by a faster speed before being moved by a slower speed.

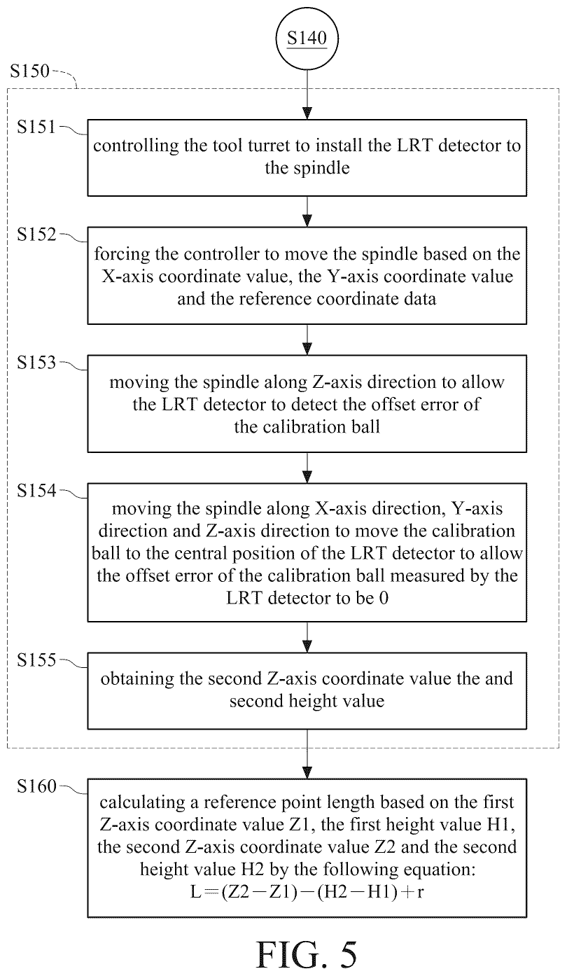

As shown in FIGS. 5, 9 and 10, then, for example, a step S150 is performed to control a tool turret 23 to install the LRT detector 30 to the spindle 22 by the controller 300, and move the spindle 22 to allow the LRT detector 30 to obtain an offset error of 0 of the calibration ball 130 by moving the calibration ball 130 to a central position of the LRT detector 30 by the controller 300, thereby allowing the computing unit 200 to obtain a second Z-axis coordinate value of the spindle 22 and a second height value H2 of the measuring device 100 relative to the first rotary unit 21. In detail, in this embodiment, the step 150 includes, for example, five steps S151-S155. In the step S151, for example, the controller 300 controls the tool turret 23 to install the LRT detector 30 to the spindle 22. In the step S152, for example, the computing unit 200 forces the controller 300 to move the spindle 22 based on the X-axis coordinate value, the Y-axis coordinate value and the reference coordinate data. For example, if the X-axis coordinate value, the Y-axis coordinate value, the X-axis reference coordinate value, and the Y-axis reference coordinate value of the reference coordinate data are respectively denoted by X1, Y1, X′ and Y′, the step S152 is to move the X-axis coordinate value from X to X′, and move the Y-axis coordinate value from Y1 to Y′. In step S153, for example, the controller 300 moves the spindle 22 along Z-axis direction to allow the LRT detector 30 to detect the offset error of the calibration ball 130. In the step S154, for example, the controller 300 moves the spindle 22 along X-axis direction, Y-axis direction and Z-axis direction to move the calibration ball 130 to the central position of the LRT detector 30 to allow the offset error of the calibration ball 130 measured by the LRT detector 30 to be 0. In the step S155, for example, the computing unit 200 obtains the second Z-axis coordinate value the and second height value H2.

Then, for example, a step S160 is performed to calculate a reference point length L based on the first Z-axis coordinate value, the first height value H1, the second Z-axis coordinate value and the second height value H2 by the computing unit 200. The reference point length L is, for example, a distance between the end 220 of the spindle 22 and a center C of the calibration ball 130. For example, the computing unit 200 calculates the reference point length L based on the following equation: L=(Z2−Z1)−(H2−H1)+r. In such equation, Z1 denotes the first Z-axis coordinate value, Z2 denotes the second Z-axis coordinate value, H1 denotes the first height value, H2 denotes the second height value, and r denotes a radius r of the calibration ball 130. The steps S110, S120, S130, S140, S141-S144, S150, S151-S155, and S160 for obtaining the reference point length L may be repeated multiple times to reduce the error of the calculation of the reference point length L.

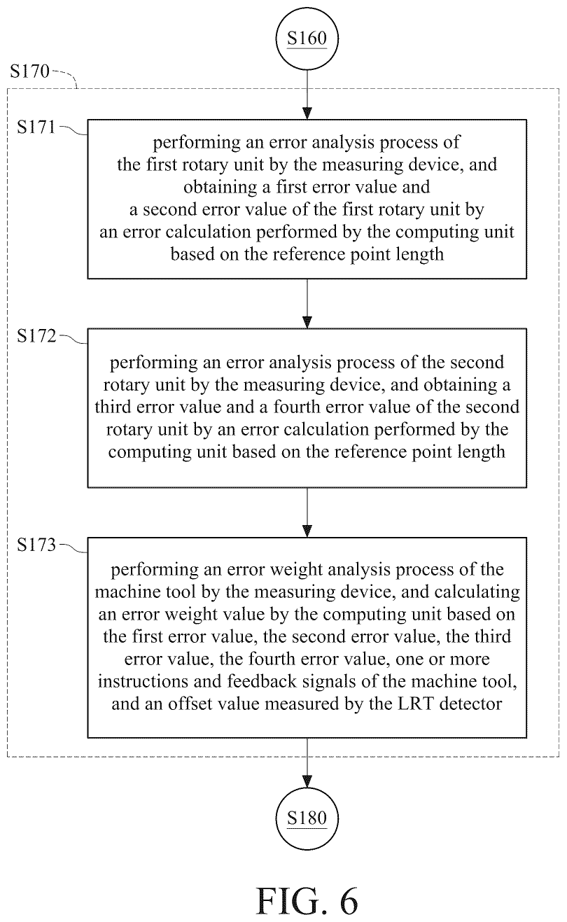

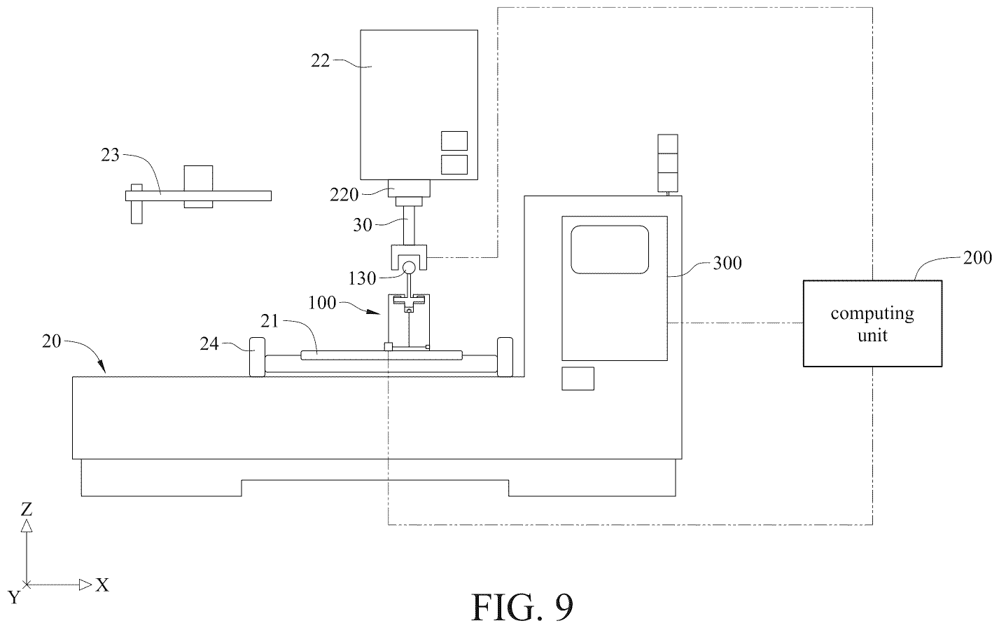

Then, please refer to FIGS. 6 and 9. For example, the same measuring device 100 and the computing unit 200 may be used to perform a step S170 to obtain an error value of the machine tool 20 by performing an error analysis based on the reference point length L. In this embodiment, the step S170 includes, for example, three steps S171-S173. In the step S171, for example, an error analysis process of the first rotary unit 21 is performed by the measuring device 100, and a first error value and a second error value of the first rotary unit 21 are obtained by an error calculation performed by the computing unit 200 based on the reference point length L. In the step S172, for example, an error analysis process of the second rotary unit 24 is performed by the measuring device 100, and a third error value and a fourth error value of the second rotary unit 24 are obtained by an error calculation performed by the computing unit 200 based on the reference point length L. In the step S173, for example, an error weight analysis process of the machine tool 20 is performed by the measuring device 100, and an error weight value is calculated by the computing unit 200 based on the first error value, the second error value, the third error value, the fourth error value, one or more instructions and one or more feedback signals of the machine tool 20, and an offset value measured by the LRT detector. In addition, since the same measuring device 100 is used to perform the step S170, the calibration ball exclusive to the LRT detector 30 may be replaced by the calibration ball 130 of the measuring device 100, thereby reducing the error caused by the removal and installation of the related components, devices or apparatus.

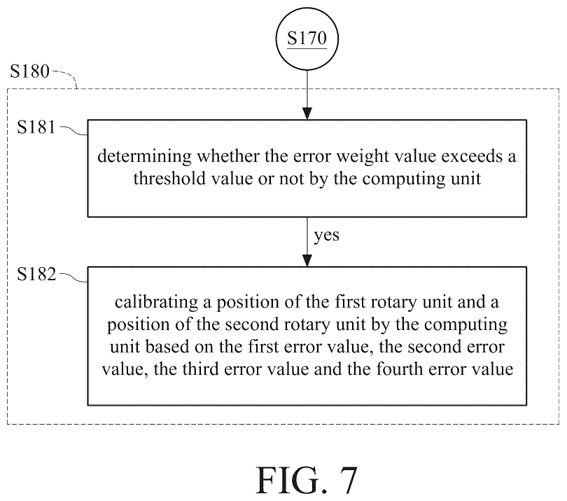

Then, please refer to FIGS. 7 and 9. For example, a step S180 is performed to calibrate the first rotary unit 21 and the second rotary unit 24 of the machine tool 20 by the computing unit 200 based on the error value (e.g., error weight value). In this embodiment, the step S180 includes, for example, two steps S181-S182. In the step S181, for example, the computing unit 200 determines whether the error weight value exceeds a threshold value or not. If the error weight value exceeds the threshold value, the step S182 is performed to, for example, calibrate a position of the first rotary unit 21 and a position of the second rotary unit 24 by the computing unit 200 based on the first error value, the second error value, the third error value and the fourth error value.

With the help of the measuring device 100 and the LRT detector 30, the reference point length L of the spindle 22 of the machine tool 20 may be measured without using the dial indicator manually. Accordingly, not only the error for measuring the reference point length L is reduced, but also the measuring process of the reference point length L is simplified and automated.

Further, by using the sensing switch 150 that is a tact switch, the measuring device 100 is allowed to operate without cooperating with additional decoder, thereby simplifying the structure of the measuring device 100 and reducing the manufacture cost thereof.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

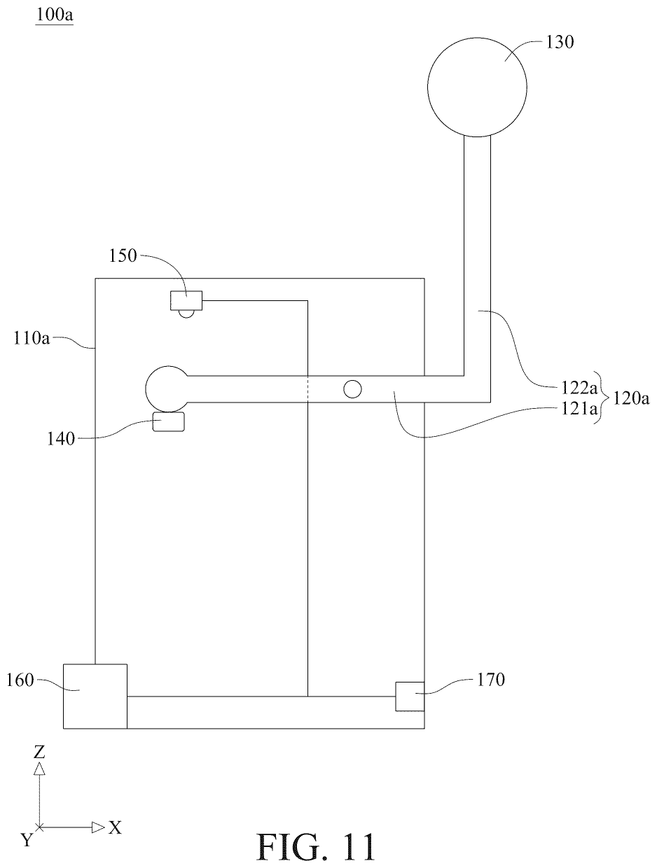

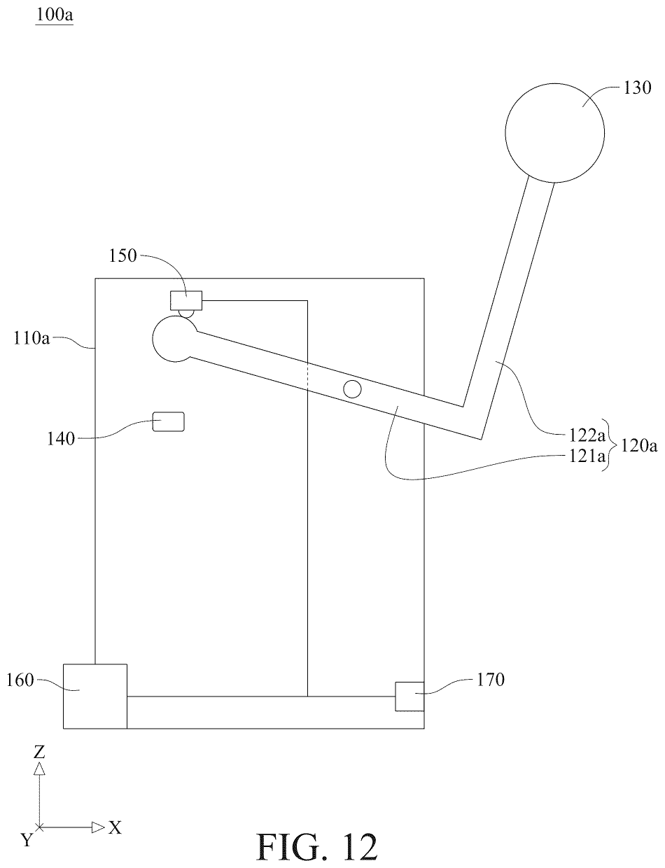

The disclosure is not limited by the connection relationship between the movable component and the housing. Please refer to FIGS. 11 and 12 that are plan views of a measuring device 100a according to a second embodiment of the disclosure.

The only difference between the measuring device 100a of this embodiment and the measuring device 100 of the first embodiment is the connection relationship between a movable component 120a and a housing 110a. In detail, in this embodiment, the movable component 120a includes, for example, a first rod part 121a and a second rod part 122a that are connected to each other. An extension direction of the first rod part 121a is, for example, perpendicular to an extension direction of the second rod part 122a. The first rod part 121a is pivotally connected to the housing 110a. An end of the first rod part 121a located away from the second rod part 122a is configured to be attracted by the magnet 140, and is configured to trigger the sensing switch 150 (as shown in FIG. 12). The calibration ball 130 is disposed on an end of the second rod part 122a located away from the first rod part 121a.

According to the measuring device and the error calibration method for the machine tool using the measuring device, the calibration ball is disposed on an end of the movable component and located outside the housing, and the sensing switch is configured to detect the movement of the movable component relative to the housing. Thus, the reference point length of the spindle of the machine tool is allowed to be measured by the measuring device and the LRT detector without using the dial indicator manually. Accordingly, not only the error for measuring the reference point length is reduced, but also the measuring process of the reference point length is simplified and automated. Further, the following error calibration performed on the machine tool based on the reference point length is allowed to be more accurate, and the process of the error calibration is allowed to be simplified and automated.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A measuring device, comprising:
a housing, having an inner space;
a movable component, movably disposed in the inner space;
a calibration ball, disposed on an end of the movable component and at least partially located outside the housing; and
a sensing switch, disposed in the inner space and configured to detect a movement of the movable component relative to the housing.

2. The measuring device according to claim 1, wherein the movable component is slidably disposed on the housing.

3. The measuring device according to claim 1, further comprising at least one magnet disposed in the inner space and configured to attract the movable component.

4. The measuring device according to claim 1, wherein the sensing switch is a tact switch.

5. The measuring device according to claim 1, wherein the movable component is pivotally connected to the housing.

6. The measuring device according to claim 1, further comprising a signal output port disposed on the housing and electrically connected to the sensing switch.

7. The measuring device according to claim 6, further comprising a light emitting component disposed on and exposed from the housing, wherein the light emitting component is electrically connected to the signal output port.

8. An error calibration method for a machine tool, using the measuring device according to claim 1, a LRT detector, a computing unit and a controller to perform an error calibration on the machine tool, the error calibration method being a series of programs performing following steps after being read by the computing unit:
forcing an end of a spindle of the machine tool to push the calibration ball disposed on the movable component by the controller, thereby obtaining a first Z-axis coordinate value of the spindle and obtaining a first height value of the measuring device based on the sensing switch in the measuring device that is configured to detect the movement of the movable component;
controlling a tool turret of the machine tool to install the LRT detector to the spindle by the controller, and moving the spindle to allow the LRT detector to obtain an offset error of 0 of the calibration ball by moving the calibration ball to a central position of the LRT detector, thereby obtaining a second Z-axis coordinate value of the spindle and a second height value of the measuring device; and
calculating a reference point length based on the first Z-axis coordinate value, the first height value, the second Z-axis coordinate value and the second height value by the computing unit.

9. The error calibration method according to claim 8, wherein forcing the spindle to push the calibration ball by the controller, thereby obtaining the first Z-axis coordinate value and the first height value comprises:
forcing the spindle to be moved along a Z-axis direction by a first speed by the controller until the movable component triggers the sensing switch;
forcing the spindle to be moved along the Z-axis direction by the controller to stop the movable component from triggering the sensing switch;
forcing the spindle to be moved along the Z-axis direction by a second speed that is slower than the first speed by the controller until the movable component triggers the sensing switch; and
obtaining an X-axis coordinate value, a Y-axis coordinate value and the first Z-axis coordinate value of the spindle and the first height value of the measuring device by the computing unit.

10. The error calibration method according to claim 8, wherein controlling the tool turret of the machine tool to install the LRT detector to the spindle by the controller, and moving the spindle to allow the LRT detector to obtain the offset error of 0 of the calibration ball by moving the calibration ball to the central position of the LRT detector, thereby obtaining the second Z-axis coordinate value and the second height value comprises:
controlling the tool turret to install the LRT detector to the spindle by the controller;
forcing the controller to move the spindle based on the X-axis coordinate value, the Y-axis coordinate value and the reference coordinate data by the computing unit;
moving the spindle along the Z-axis direction by the controller to allow the LRT detector to detect the offset error of the calibration ball;
moving the spindle along an X-axis direction, a Y-axis direction and the Z-axis direction by the controller to move the calibration ball to the central position of the LRT detector; and
obtaining the second Z-axis coordinate value and the second height value by the computing unit.

11. An error calibration method for a machine tool, using the measuring device according to claim 1, a LRT detector, a computing unit and a controller to perform an error calibration on the machine tool, the error calibration method being a series of programs performing following steps after being read by the computing unit:
using the measuring device and the computing unit to obtain an error value of the machine tool by performing an error analysis based on a reference point length; and
calibrating a first rotary unit and a second rotary unit of the machine tool by the computing unit based on the error value of the machine tool.

12. The error calibration method according to claim 11, wherein using the measuring device and the computing unit to obtain the error value of the machine tool by performing the error analysis based on the reference point length comprises:
performing an error analysis process of the first rotary unit by the measuring device, and obtaining a first error value and a second error value of the first rotary unit by an error calculation performed by the computing unit based on the reference point length;
performing an error analysis process of the second rotary unit by the measuring device, and obtaining a third error value and a fourth error value of the second rotary unit by an error calculation performed by the computing unit based on the reference point length; and
performing an error weight analysis process of the machine tool by the measuring device, and calculating an error weight value by the computing unit based on the first error value, the second error value, the third error value, the fourth error value, one or more instructions and one or more feedback signals of the machine tool, and an offset value measured by the LRT detector.

13. The error calibration method according to claim 11, wherein calibrating the first rotary unit and the second rotary unit of the machine tool by the computing unit based on the error value of the machine tool comprises:
determining whether the error weight value exceeds a threshold value or not by the computing unit; if the error weight value exceeds the threshold value, a position of the first rotary unit and a position of the second rotary unit are calibrated by the computing unit based on the first error value, the second error value, the third error value and the fourth error value
